(19) United States
(12) Patent Application Publication
(10) Pub. No.: US 2012/0232447 A1
(43) Pub. Date: Sep. 13, 2012

(54) SYSTEMS AND METHODS FOR DEEP VEIN THROMBOSIS PROPHYLAXIS

(76) Inventors: Charles Gordon, Tyler, TX (US); Grant Gordon, Tyler, TX (US); Abigail Gordon, Tyler, TX (US)

(21) Appl. No.: 13/414,099

(22) Filed: Mar. 7, 2012

Related U.S. Application Data
(60) Provisional application No. 61/449,850, filed on Mar. 7, 2011.

(51) Int. Cl. A61H 7/00

(52) U.S. Cl. 601/151

(57) ABSTRACT

Systems, methods, and kits for deep vein thrombosis prophylaxis.

### CROSS REFERENCE TO RELATED APPLICATIONS

This application claims priority to U.S. Provisional Patent Application Ser. No. 61/449,850 filed Mar. 7, 2011, the entire contents of which are incorporated herein by reference.

### FIELD OF THE INVENTION

Exemplary embodiments of the present disclosure comprise systems and methods of deep vein thrombosis (DVT) prophylaxis for ambulatory patients.

### BACKGROUND INFORMATION

Exemplary embodiments are configured treat or prevent the problem of deep venous thrombosis that occurs in patients who have had surgery or patients who experience immobility for any reason. There are currently a number of treatments that are available including blood thinners, placement of intravascular filters, as well as the use of sequential compression devices (or SCDs) that can be affixed to the legs. The human venous system in the lower extremities utilizes veins having one-way valves that allow the blood to flow up towards the heart and prevent blood from flowing backwards.

However, patients who are immobile for any reason are at increased risk for DVT. This includes patients who are wearing a lower extremity cast, patients who are using crutches, and those who have had any type of surgery, but particularly orthopedic surgery. Another group of patients who are at risk for DVT include those who are hypercoagulable, people whose blood is too viscous (e.g., “thick”), patients who are obese, patients who smoke, and patients who use birth control pill.

Another group of people who may benefit from the exemplary embodiments disclosed herein are those people who have chronic venous insufficiency. There is a group of patients, particularly diabetics, who have problems with the valves in their lower extremities, so they suffer from edema, e.g., swelling in the lower extremities.

Over the last several years there has been a widespread adoption of perioperative sequential compression devices. These include tight stockings called TEDs (tension elastic device), small compressors on the feet, and the compressive blow-up pillows that are placed on a patient's legs. The pillows can inflate with air and squeeze and then release pressure on the lower extremities.

Known existing sequential devices are configured for inpatient use. These systems typically have an electrical cord that plugs into an electrical outlet and require that the system be unplugged when the patient ambulates. While relatively effective while the patient is receiving treatment in a clinical setting, the systems are not designed for home use and are quite cumbersome.

Exemplary embodiments of the present disclosure are configured to provide DVT prophylaxis from the time the patient leaves the hospital. For example, data indicates that patients are still at risk of DVT for up to three weeks after a surgical intervention. The embodiments disclosed herein can be used by the patient outside of the hospital or other clinical setting and therefore reduce the likelihood of DVT formation.

A long-felt need therefore exists for systems that can be utilized by a patient to treat or prevent DVT after the patient has been discharged from a hospital but is still at risk of developing DVT.

### SUMMARY

Exemplary embodiments of the present disclosure provide novel systems, kits, and methods for deep vein thrombosis (DVT) prophylaxis for ambulatory patients.

### BRIEF DESCRIPTION OF THE FIGURES

While exemplary embodiments of the present invention have been shown and described in detail below, it will be clear to the person skilled in the art that changes and modifications may be made without departing from the scope of the invention. As such, that which is set forth in the following description and accompanying drawings is offered by way of illustration only and not as a limitation. The actual scope of the invention is intended to be defined by the following claims, along with the full range of equivalents to which such claims are entitled.

In addition, one of ordinary skill in the art will appreciate upon reading and understanding this disclosure that other variations for the invention described herein can be included within the scope of the present invention. For example, different materials of construction may be used for the clamps or coupling members employed in the kit or system. Furthermore, the shape of individual clamps or coupling members may also be altered.

In the following Detailed Description of Exemplary Embodiments, various features are grouped together in several embodiments for the purpose of streamlining the disclosure. This method of disclosure is not to be interpreted as reflecting an intention that exemplary embodiments of the invention require more features than are expressly recited in each claim. Rather, as the following claims reflect, inventive subject matter lies in less than all features of a single disclosed embodiment. Thus, the following claims are hereby incorporated into the Detailed Description of Exemplary Embodiments, with each claim standing on its own as a separate embodiment.

Identical reference numerals do not necessarily indicate an identical structure. Rather, the same reference numeral may be used to indicate a similar feature or a feature with similar functionality. Not every feature of each embodiment is labeled in every figure in which that embodiment appears, in order to keep the figures clear. Similar reference numbers (e.g., those that are identical except for the first numeral) are used to indicate similar features in different embodiments.

FIG. 1A is a side view of an exemplary embodiment of a deep vein thrombosis prophylaxis system.

FIG. 1B is a section view of the embodiment of FIG. 1A.

FIG. 1C is a view of the embodiment of FIG. 1A located on a patient.

FIG. 2A is a side view of an exemplary embodiment of a deep vein thrombosis prophylaxis system.

FIG. 2B is a section view of the embodiment of FIG. 2A.

FIG. 2C is a view of the embodiment of FIG. 2A located on a patient.

FIG. 3A is a side view of an exemplary embodiment of a deep vein thrombosis prophylaxis system.

FIG. 3B is a section view of the embodiment of FIG. 3A.

FIG. 4A is a side view of an exemplary embodiment of a deep vein thrombosis prophylaxis system.

FIG. 4B is a section view of the embodiment of FIG. 4A.

FIG. 5A is a side view of an exemplary embodiment of a deep vein thrombosis prophylaxis system.

FIG. 5B is a section view of the embodiment of FIG. 5A.

FIGS. 6A and 6B are section views of an exemplary embodiment of a deep vein thrombosis prophylaxis system.

FIGS. 7A and 7B are section views of an exemplary embodiment of a deep vein thrombosis prophylaxis system.

FIGS. 8A and 8B are section views of an exemplary embodiment of a deep vein thrombosis prophylaxis system.

FIGS. 9A and 9B are section views of an exemplary embodiment of a deep vein thrombosis prophylaxis system.

FIG. 10 is a section view of an exemplary embodiment of a deep vein thrombosis prophylaxis system.

FIG. 11 is a section view of an exemplary embodiment of a deep vein thrombosis prophylaxis system.

FIG. 12 is a section view of an exemplary embodiment of a deep vein thrombosis prophylaxis system.

FIG. 13 is a section view of an exemplary embodiment of a deep vein thrombosis prophylaxis system.

### DETAILED DESCRIPTION OF EXEMPLARY EMBODIMENTS

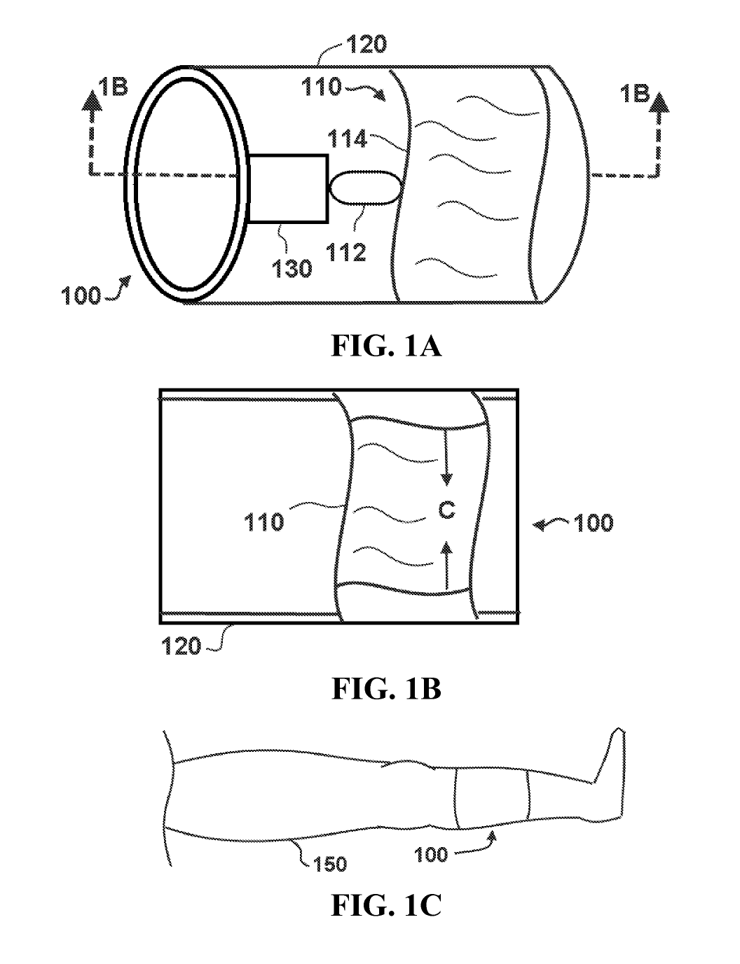

In an exemplary embodiment shown in FIGS. 1A-1C, a deep vein thrombosis (DVT) prophylaxis system 100 includes a compression device 110, a coupling mechanism 120, and a portable energy source 130. FIG. 1A provides an external side view of system 100, while FIG. 1B illustrates a section view of system 100 taken along line 1B-1B of FIG. 1A.

As explained in further detail below, system 100 is configured to be coupled via coupling mechanism 120 to a patient 150, e.g., at a location on the patient's leg or other area susceptible to DVT, as shown in FIG. 1C. As used herein, the term “patient” should be construed broadly, and is not limited to a person in a clinical setting such as a hospital or doctor's office. For example, a patient may include any person utilizing system 100.

Portable energy source 130 may then be energized to activate compression device 110 so that it exerts a compressive force on patient 150 and reduces the likelihood that blood could pool or accumulate and result in DVT. In exemplary embodiments, portable energy source 130 is configured to provide sufficient energy to compression device 110 without the need to couple to stationary energy sources, e.g. electrical outlets or other sources that would restrict movement of patient 150.

In this exemplary embodiment, coupling mechanism 120 may comprise an elastic sleeve or band that can be placed or wrapped around the patient's leg. In other embodiments, coupling mechanism 120 may be configured to couple system 100 to other portions of patient 150. For example, coupling mechanism 120 may be configured as a boot that can be worn by patient 150.

In certain embodiments, coupling mechanism 120 may also comprise a fastening member such as a hook-and-loop fastener (commonly sold under the trade name Velcro®) or other suitable fastener to secure coupling mechanism 120 in place. In exemplary embodiments, coupling mechanism 120 can be configured as a “universal” fit to couple to a wide variety of patient sizes. In the embodiment shown, compression device 110 comprises an air compressor 112 and a bladder 114. During operation, portable energy source 130 can be used to power air compressor 112 such that it can inflate and deflate bladder 114. As bladder 114 inflates and expands, it can exert a compressive force on patient 150.

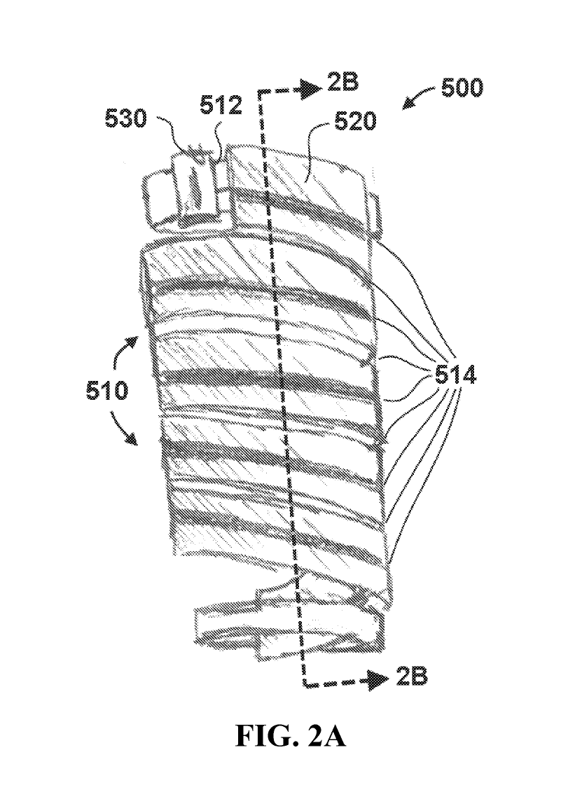

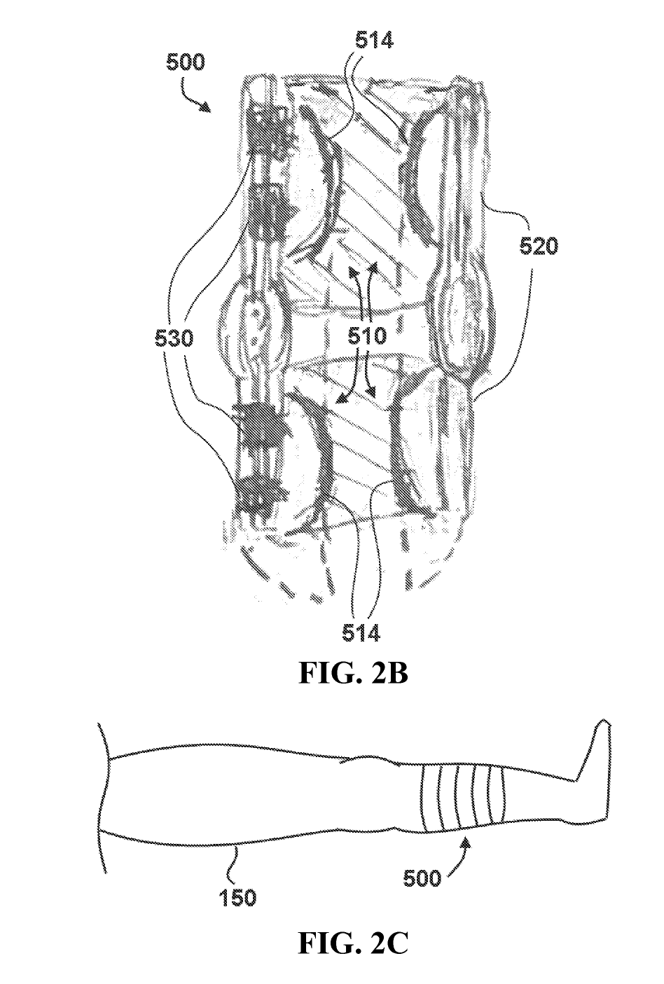

Coupling mechanism 120 can be used to restrict the expansion of bladder 114 in the outward direction (e.g., the direction away from the patient). In this manner, the expansion of bladder 114 can exert a sufficient compressive force towards the patient (e.g., in the direction indicated by arrows labeled “C” in FIG. 2) to reduce blood pooling and accumulation. Energy source 130 and air compressor 112 can be configured to cyclically inflate and deflate bladder 114, providing an alternating or cyclical compressive force to the patient. It is established in the field that such cyclical application of compressive forces can reduce the likelihood of the patient developing DVT.

In certain embodiments, energy source 130 may be comprise a rechargeable battery pack worn on the patient's belt, vest, or other suitable location and coupled to compression device 110. In certain embodiments, other components of system 100 may also be located remotely on the patient. For example, air compressor 112 may also be located remotely and coupled to bladder 114 via conduit.

Locating components of energy source 130 remotely from compression device 110, but still on the patient, can allow for larger components (e.g., batteries) and increase the amount of energy potentially available. This can potentially increase the effectiveness of system 100 by allowing for longer operation times or increased compressive forces.

Referring now to FIGS. 2A-2C, another exemplary embodiment of a DVT prophylaxis system 500 is illustrated. FIG. 2A provides an external side view of system 500, while FIG. 2B illustrates a section view of system 500 taken along line 2B-2B of FIG. 2A. The general principles of operation of this embodiment are similar to those described above in embodiment FIGS. 1A-1C. However, in this embodiment coupling member 520 comprises an elastic wrap.

In certain embodiments, coupling member 520 may comprise a separate component from compression device 510. For example, compression device 510 may comprise an elongate air bladder 514 that can be wrapped around the area of the patient to be treated. Coupling member 510 can be wrapped around compression device 510 and secure air bladder 514 to the patient. In a manner similar to that described above in the discussion of FIGS. 1A-1C, portable energy source 530 can be used to supply power to compressor 512 and inflate and deflate air bladder 514 of compression device 510 to prevent or treat DVT.

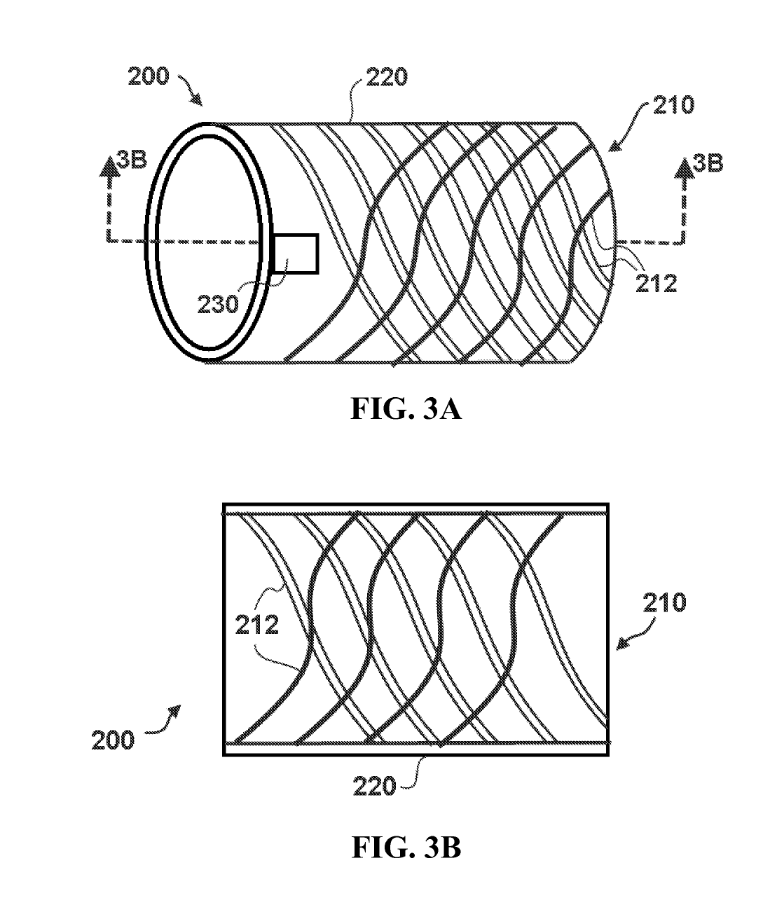

Referring now to FIGS. 3A and 3B, another exemplary embodiment of a DVT prophylaxis system 200 is illustrated. FIG. 3A provides an external side view of system 200, while FIG. 3B illustrates a section view of system 100 taken along line 3B-3B of FIG. 3A. The general principles of operation of this embodiment are similar to those described above in embodiment FIGS. 1A-1C and 2A-2C.

However, in this embodiment, system 200 includes a compression device 210 comprising a shape memory alloy 212. During operation, energy source 230 can provide energy (e.g., electrical or thermal energy) to compression device 210 such that shape memory alloy 212 changes shape. In specific embodiments, shape memory alloy 212 may change shape such that it contracts and exerts a compressive force on the patient. Energy source 230 can be cyclically energized and de-energized to provide a cyclic or alternating compressive force to the patient.

In particular exemplary embodiments, shape memory alloy 212 may be integrated, inlayed or embedded into coupling mechanism 220. In specific embodiments, shape memory alloy 212 may be integrated, inlayed or embedded in an interwoven, crisscrossed, or serpentine arrangement.

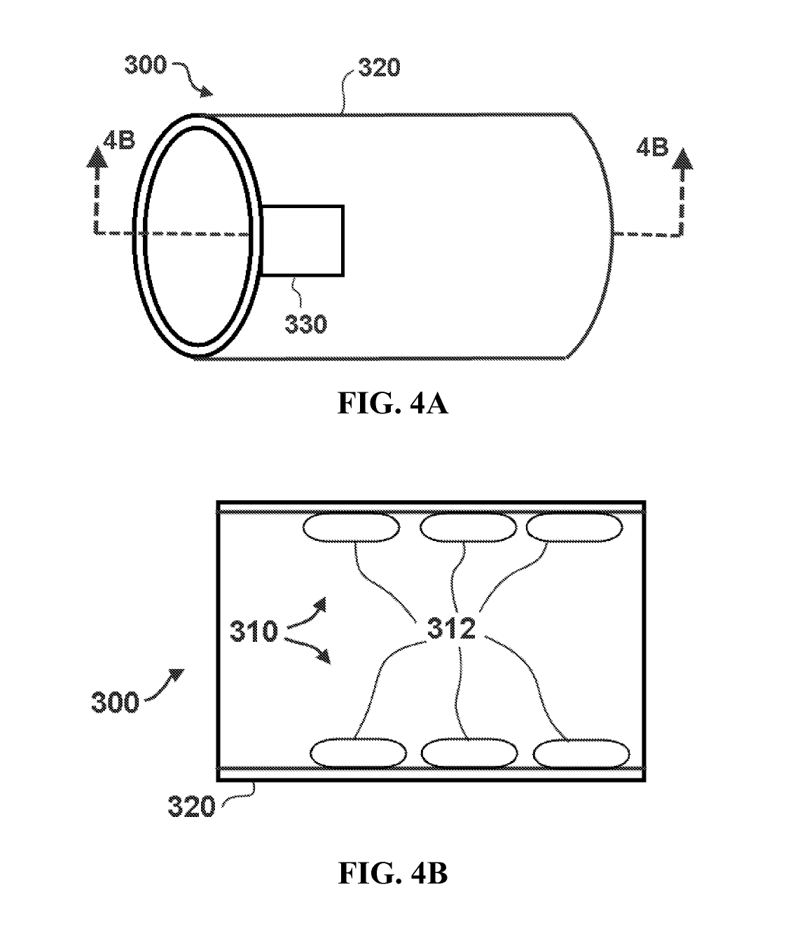

Referring now to FIGS. 4A and 4B, another exemplary embodiment of a DVT prophylaxis system 300 is illustrated. FIG. 4A provides an external side view of system 300, while FIG. 4B illustrates a section view of system 300 taken along line 4B-4B of FIG. 4A.

The general principles of operation of this embodiment are similar to those described above in embodiment of FIGS. 1A-1C and 2A-2C. However, in this embodiment, system 300 includes a compression device 310 utilizing mechanical rollers 312. During operation, energy source 330 can be activated to initiate rotation of mechanical rollers 312. In certain embodiments, energy source 330 may comprise a portable, rechargeable battery pack that is configured to supply energy to an electric motor (not shown) or other suitable mechanism configured to rotate mechanical rollers 312.

In the exemplary embodiment shown, mechanical rollers 312 are configured to generate a compressive force against the patient. In certain embodiments, mechanical rollers 312 may be eccentric rollers so that the compressive force is cyclically applied to the patient as the mechanical rollers are rotated.

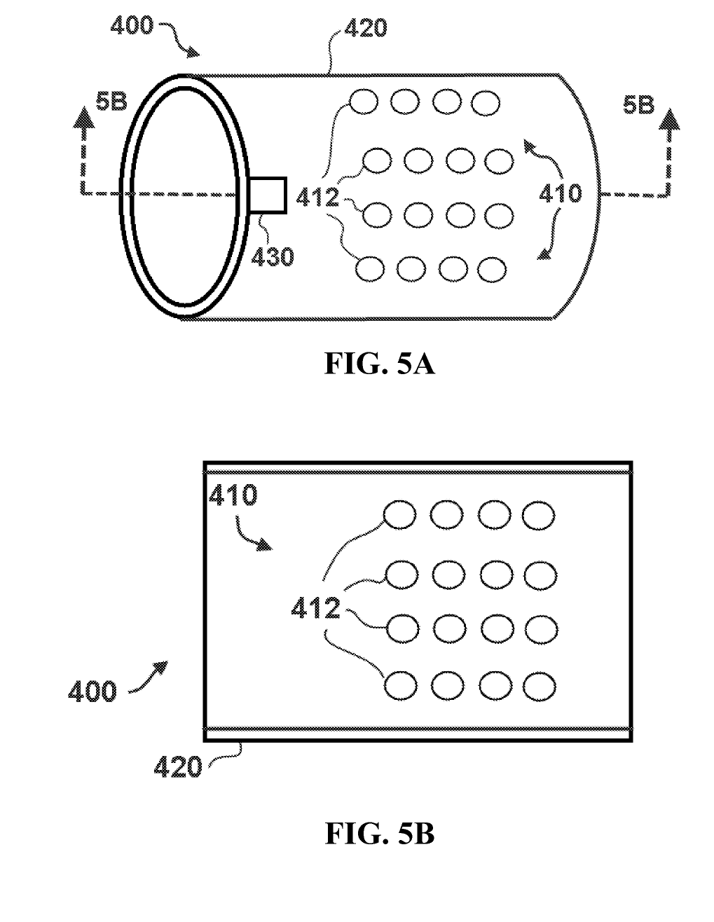

Referring now to FIGS. 5A and 5B, another exemplary embodiment of a DVT prophylaxis system 400 is illustrated. FIG. 5A provides an external side view of system 400, while FIG. 5B illustrates a section view of system 400 taken along line 5B-5B of FIG. 5A.

The general principles of operation of this embodiment are similar to those described above in embodiment FIGS. 1A-1C and 2A-2C. However, in this embodiment, system 400 includes a compression device 410 utilizing ultrasonic emitters 412. During operation, energy source 430 can be energized to cause ultrasonic emitters 412 to emit ultrasonic energy (e.g., ultrasonic pressure waves) that are directed toward the patient. The ultrasonic pressure waves can help to prevent the formation of internal blood clots and reduce the likelihood of DVT in the patient.

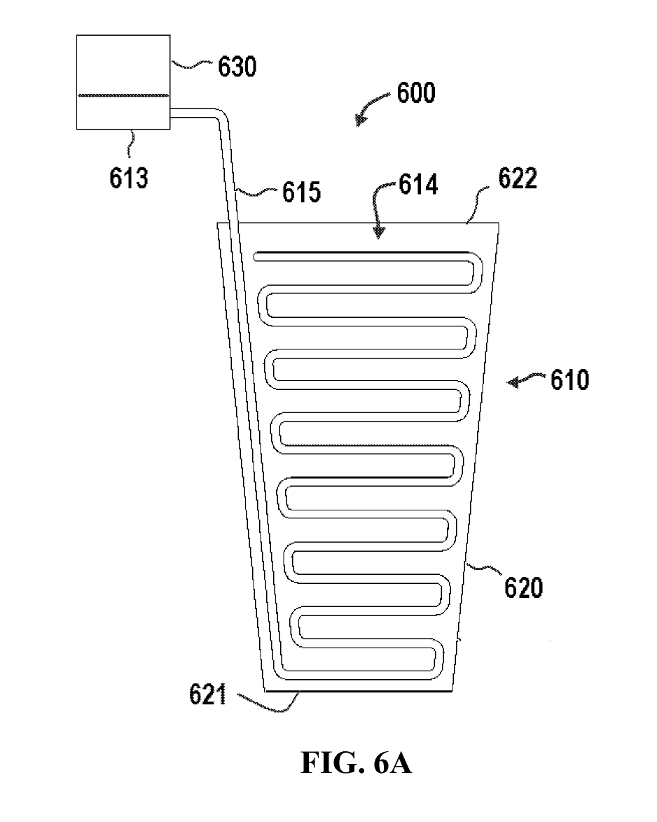

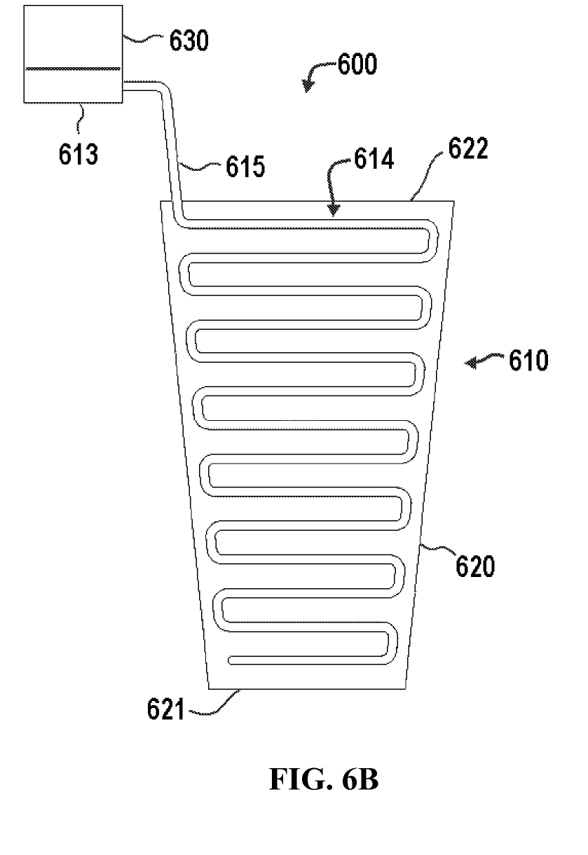

Referring now to FIGS. 6A and 6B, another exemplary embodiment of a DVT prophylaxis system 600 is illustrated. The general principles of operation of this embodiment are similar to those described above in embodiment of FIGS. 1A-1C and 2A-2C.

In this embodiment, system 600 is configured to be coupled via coupling mechanism 620 to a patient (not shown). System 600 includes a compression device 610 and a portable energy source 630, which is coupled to an air compressor 613 that is in fluid communication with conduit 615. In this embodiment, bladder 614 is formed by arranging conduit 615 in a pattern coupled to compression device 610. In the specific embodiment shown, bladder 614 is formed by arranging conduit 615 in a continuous series of parallel segments in fluid communication. It is understood that other embodiments may comprise a different pattern of conduit 615 arranged to form bladder 614.

In this exemplary embodiment, coupling mechanism 620 may comprise an elastic sleeve or band that can be placed or wrapped around the patient's leg. In other embodiments, coupling mechanism 620 may be configured to couple system 600 to other portions of a patient.

Similar to previously-described embodiments, portable energy source 630 may be energized to activate compression device 610 so that it exerts a compressive force on a patient to reduce the likelihood that blood could pool or accumulate and result in DVT. For example, during operation, portable energy source 630 can be used to power air compressor 613 such that it can inflate and deflate bladder 614. As bladder 614 inflates and expands, it can exert a compressive force on a patient. In the embodiment shown in FIG. 6A, conduit 615 is coupled to bladder 614 near a distal end 621 of compression device 610. In the embodiment shown in FIG. 6B, conduit 615 is coupled to bladder 614 near a proximal end 622 of compression device 610.

Coupling mechanism 620 can be used to restrict the expansion of bladder 614 in the outward direction (e.g., the direction away from the patient). In this manner, the expansion of bladder 614 can exert a sufficient compressive force towards the patient to reduce blood pooling and accumulation. Energy source 630 and air compressor 613 can be configured to cyclically inflate and deflate bladder 614, providing an alternating or cyclical compressive force to the patient.

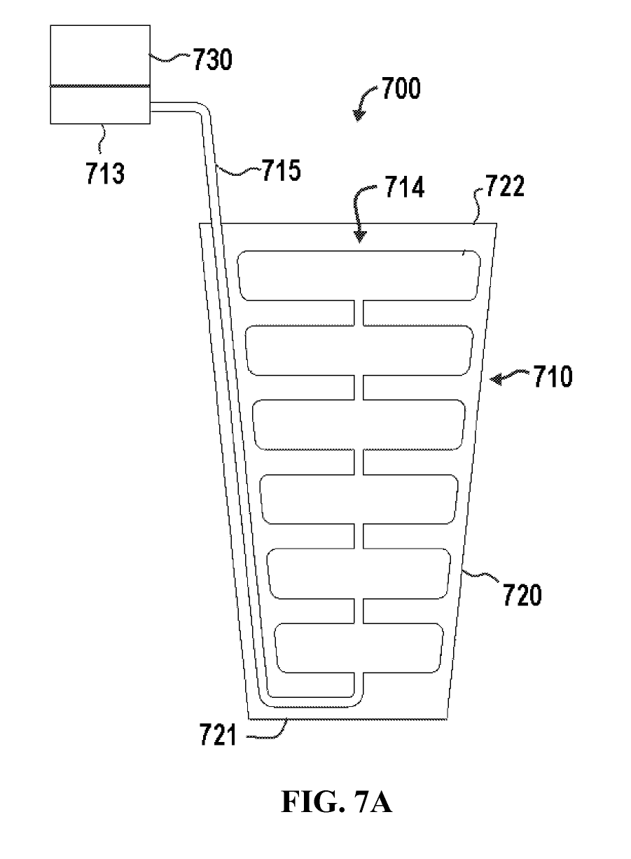

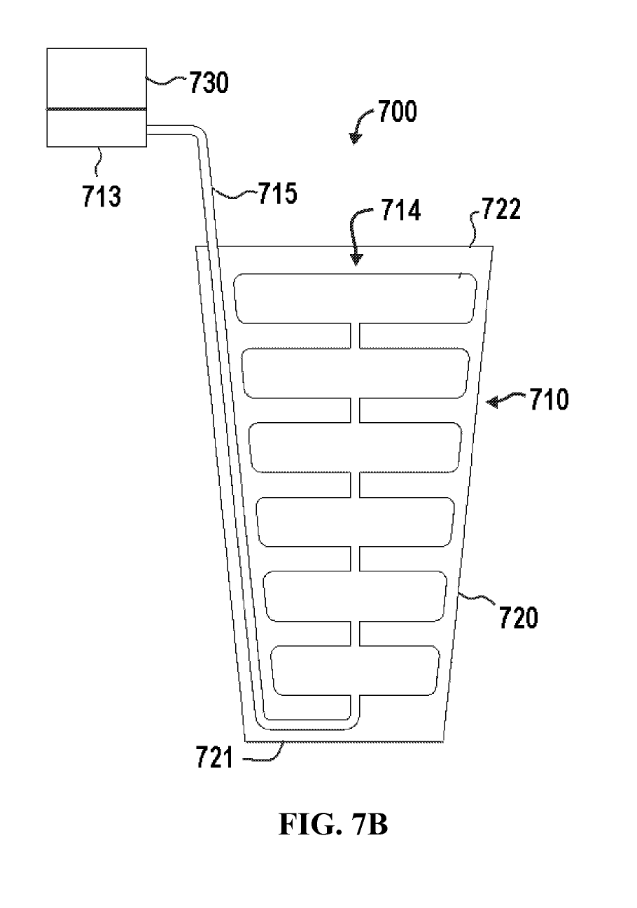

Referring now to FIGS. 7A and 7B, another exemplary embodiment of a DVT prophylaxis system 700 is illustrated. The general principles of operation of this embodiment are similar to those described above in embodiment of FIGS. 1A-1C and 2A-2C.

In this embodiment, system 700 is configured to be coupled via coupling mechanism 720 to a patient (not shown). System 700 includes a compression device 710 and a portable energy source 730, which is coupled to an air compressor 713 that is in fluid communication with conduit 715. In this embodiment, conduit 713 is in fluid communication with bladder 714, which includes a plurality of individual compartments arranged along compression device 710. In the embodiment shown in FIG. 7A, conduit 715 is coupled to bladder 714 near a distal end 721 of compression device 710. In the embodiment shown in FIG. 7B, conduit 715 is coupled to bladder 714 near a proximal end 722 of compression device 710.

In this exemplary embodiment, coupling mechanism 720 may comprise an elastic sleeve or band that can be placed or wrapped around the patient's leg. In other embodiments, coupling mechanism 720 may be configured to couple system 700 to other portions of a patient.

Similar to previously-described embodiments, portable energy source 730 may be energized to activate compression device 710 so that it exerts a compressive force on a patient to reduce the likelihood that blood could pool or accumulate and result in DVT. For example, during operation, portable energy source 730 can be used to power air compressor 713 such that it can inflate and deflate bladder 714. As bladder 714 inflates and expands, it can exert a compressive force on a patient. Coupling mechanism 720 can be used to restrict the expansion of bladder 714 in the outward direction (e.g., the direction away from the patient). In this manner, the expansion of bladder 714 can exert a sufficient compressive force towards the patient to reduce blood pooling and accumulation. Energy source 730 and air compressor 713 can be configured to cyclically inflate and deflate bladder 714, providing an alternating or cyclical compressive force to the patient.

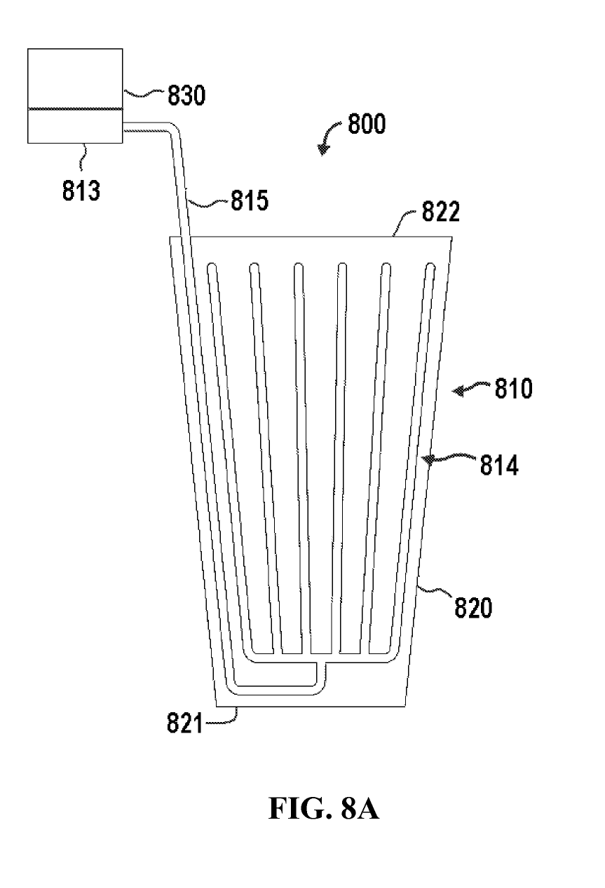

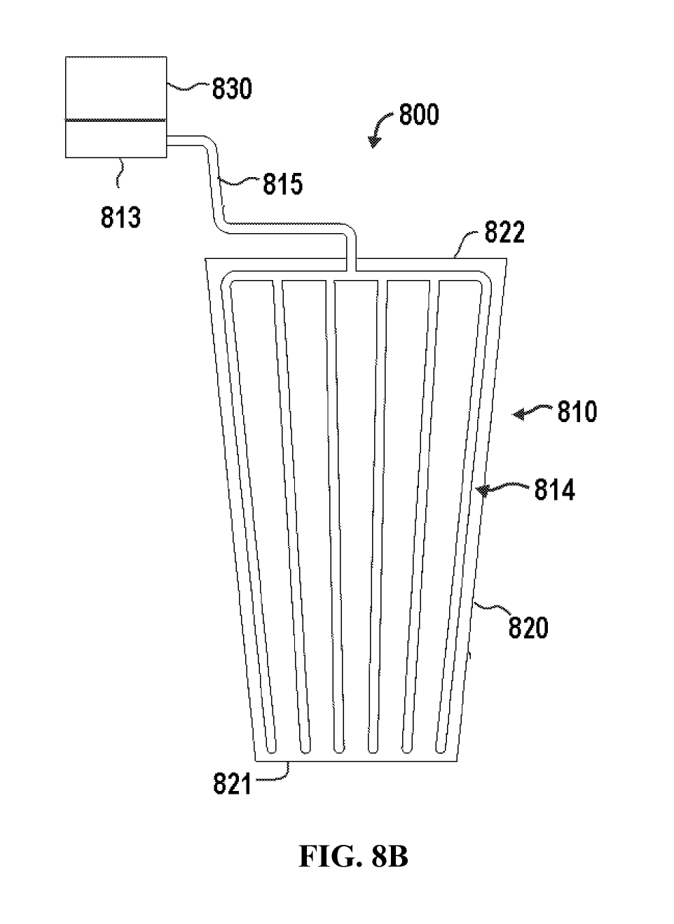

Referring now to FIGS. 8A and 8B, another exemplary embodiment of a DVT prophylaxis system 800 is illustrated. The general principles of operation of this embodiment are similar to those described above in embodiment of FIGS. 1A-1C and 2A-2C.

In this embodiment, system 800 is configured to be coupled via coupling mechanism 820 to a patient (not shown). System 800 includes a compression device 810 and a portable energy source 830, which is coupled to an air compressor 813 that is in fluid communication with conduit 815. In this embodiment, bladder 814 is formed by arranging conduit 815 in a pattern coupled to compression device 810. In the specific embodiment shown, bladder 814 is formed by arranging conduit 815 in a continuous series of parallel segments in fluid communication. In this embodiment the parallel segments of bladder 814 are arranged generally along the length of compression device 815 (rather than transverse to the length of the compression device, as shown in the embodiment of FIGS. 6A and 6B). It is understood that other embodiments may comprise a different pattern of conduit 815 arranged to form bladder 814.

In this exemplary embodiment, coupling mechanism 820 may comprise an elastic sleeve or band that can be placed or wrapped around the patient's leg. In other embodiments, coupling mechanism 820 may be configured to couple system 800 to other portions of a patient.

Similar to previously-described embodiments, portable energy source 830 may be energized to activate compression device 810 so that it exerts a compressive force on a patient to reduce the likelihood that blood could pool or accumulate and result in DVT. For example, during operation, portable energy source 830 can be used to power air compressor 813 such that it can inflate and deflate bladder 814. As bladder 814 inflates and expands, it can exert a compressive force on a patient. In the embodiment shown in FIG. 8A, conduit 815 is coupled to bladder 814 near a distal end 821 of compression device 810. In the embodiment shown in FIG. 8B, conduit 815 is coupled to bladder 814 near a proximal end 822 of compression device 810.

Coupling mechanism 820 can be used to restrict the expansion of bladder 814 in the outward direction (e.g., the direction away from the patient). In this manner, the expansion of bladder 814 can exert a sufficient compressive force towards the patient to reduce blood pooling and accumulation. Energy source 830 and air compressor 813 can be configured to cyclically inflate and deflate bladder 814, providing an alternating or cyclical compressive force to the patient.

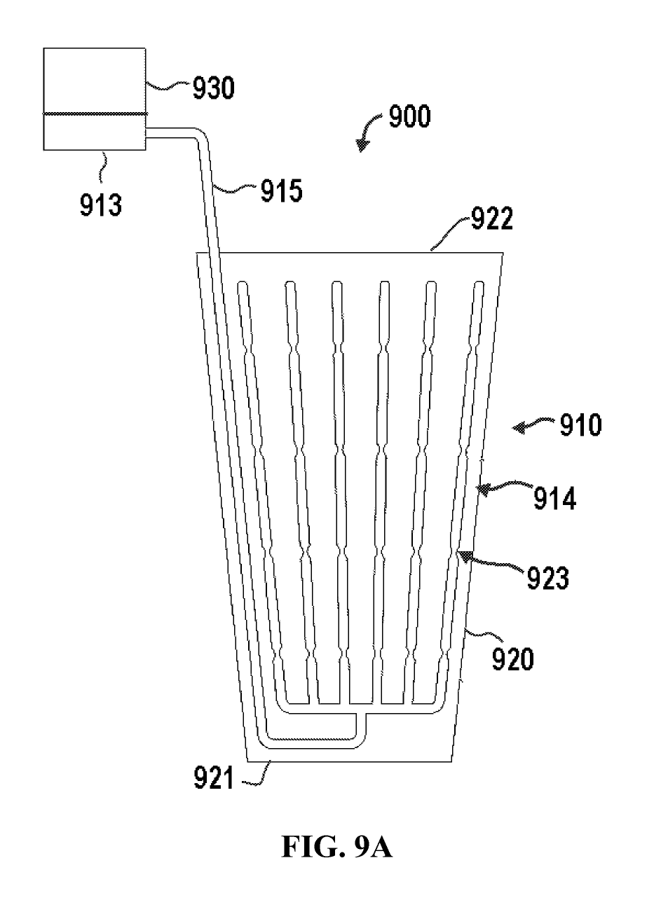

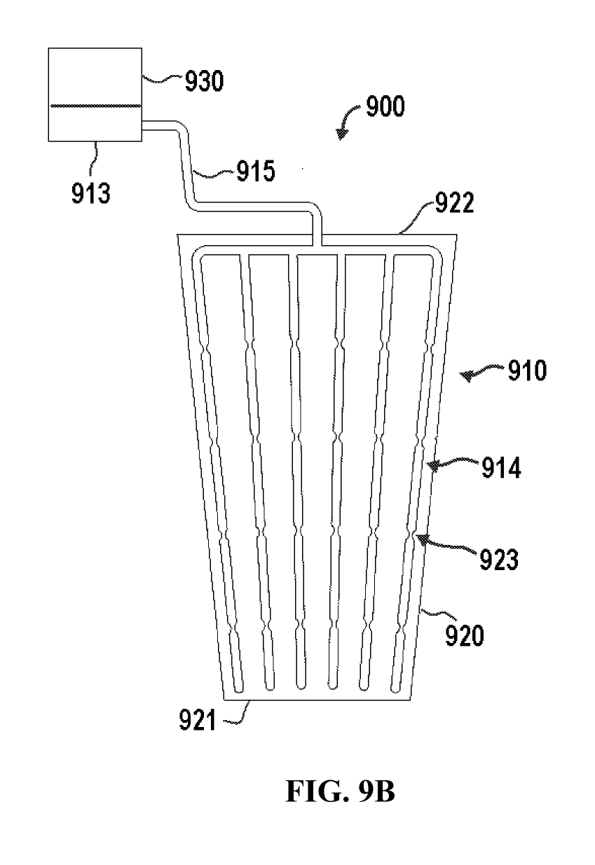

Referring now to FIGS. 9A and 9B, another exemplary embodiment of a DVT prophylaxis system 900 is illustrated. The general principles of operation of this embodiment are similar to those described above in embodiment of FIGS. 9A-9B.

In this embodiment, system 900 is configured to be coupled via coupling mechanism 920 to a patient (not shown). System 900 includes a compression device 910 and a portable energy source 930, which is coupled to an air compressor 913 that is in fluid communication with conduit 915. In this embodiment, bladder 914 is formed by arranging conduit 915 in a pattern coupled to compression device 910. In the specific embodiment shown, bladder 914 is formed by arranging conduit 915 in a continuous series of parallel segments in fluid communication. In this embodiment the parallel segments of bladder 914 are arranged generally along the length of compression device 815, similar to the embodiment shown in FIGS. 8A and 8B. In this embodiment, the individual segments of bladder 914 comprise orifices or restrictions 923. It is understood that other embodiments may comprise a different pattern of conduit 915 arranged to form bladder 914.

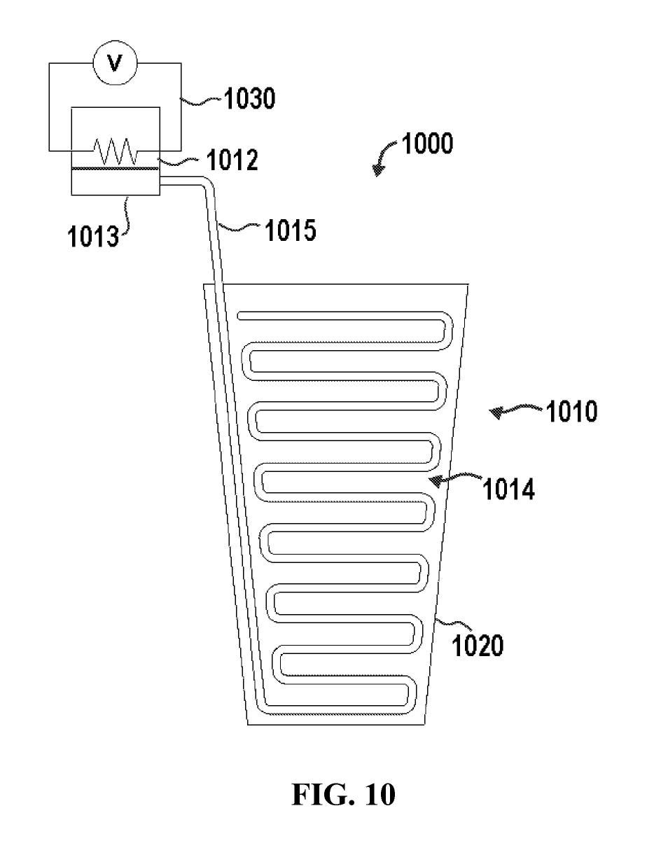

Referring now to FIG. 10, another exemplary embodiment of a DVT prophylaxis system 1000 is illustrated. The general configuration of this embodiment is similar to that described above in the embodiment of FIG. 6A. In this embodiment, however, a heater 1012 is incorporated in addition to an air compressor 1013. In this exemplary embodiment, a coupling mechanism 1020 may comprise an elastic sleeve or band that can be placed or wrapped around the patient's leg. In other embodiments, coupling mechanism 1020 may be configured to couple system 1000 to other portions of a patient.

In this embodiment, portable energy source 1030 may be energized to increase the temperature of heater 1012, which is coupled to conduit 1013, and increase the air pressure in air compressor 1013 and conduit 1015. Compression device 1010 is configured so that it exerts a compressive force on a patient to reduce the likelihood that blood could pool or accumulate and result in DVT. For example, during operation, portable energy source 1030 can be used increase the temperature and pressure of compression device 1010 to increase blood flow to the area of the patient proximal to compression device 1010.

Coupling mechanism 1020 can be used to restrict the expansion of bladder 1014 in the outward direction (e.g., the direction away from the patient). In this manner, the expansion of bladder 1014 can exert a sufficient compressive force towards the patient to reduce blood pooling and accumulation. Energy source 1030 and air compressor 1013 can be configured to cyclically inflate and deflate bladder 1014, providing an alternating or cyclical compressive force to the patient.

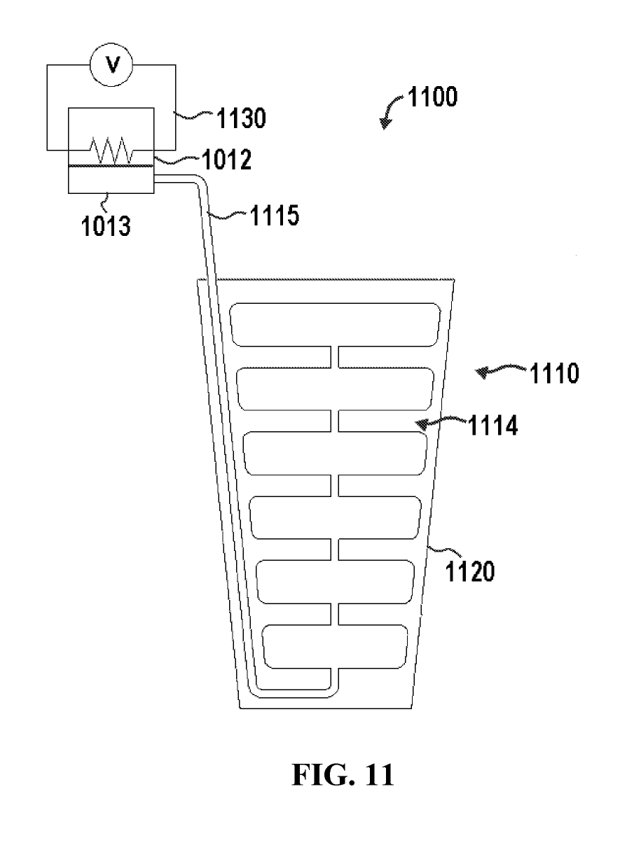

Referring now to FIG. 11, another exemplary embodiment of a DVT prophylaxis system 1100 is illustrated. The general configuration of this embodiment is similar to that described above in the embodiment of FIG. 7A. In this embodiment, however, a heater 1112 is incorporated in addition to an air compressor 1113. In this exemplary embodiment, a coupling mechanism 1120 may comprise an elastic sleeve or band that can be placed or wrapped around the patient's leg. In other embodiments, coupling mechanism 1120 may be configured to couple system 1100 to other portions of a patient.

In this embodiment, portable energy source 1130 may be energized to increase the temperature of heater 1112, which is coupled to conduit 1113, and increase the air pressure in air compressor 1113 and conduit 1115. Compression device 1110 is configured so that it exerts a compressive force on a patient to reduce the likelihood that blood could pool or accumulate and result in DVT. For example, during operation, portable energy source 1130 can be used increase the temperature and pressure of compression device 1110 to increase blood flow to the area of the patient proximal to compression device 1110.

Coupling mechanism 1120 can be used to restrict the expansion of bladder 1114 in the outward direction (e.g., the direction away from the patient). In this manner, the expansion of bladder 1114 can exert a sufficient compressive force towards the patient to reduce blood pooling and accumulation. Energy source 1130 and air compressor 1113 can be configured to cyclically inflate and deflate bladder 1114, providing an alternating or cyclical compressive force to the patient.

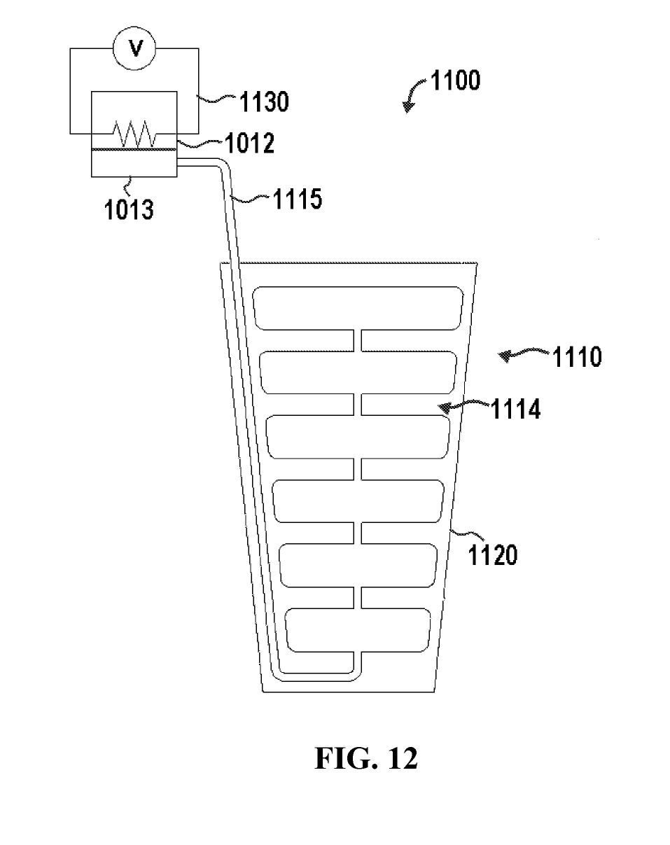

Referring now to FIG. 12, another exemplary embodiment of a DVT prophylaxis system 1200 is illustrated. The general configuration of this embodiment is similar to that described above in the embodiment of FIG. 8A. In this embodiment, however, a heater 1212 is incorporated in addition to an air compressor 1213. In this exemplary embodiment, a coupling mechanism 1220 may comprise an elastic sleeve or band that can be placed or wrapped around the patient's leg. In other embodiments, coupling mechanism 1220 may be configured to couple system 1200 to other portions of a patient.

In this embodiment, portable energy source 1230 may be energized to increase the temperature of heater 1212, which is coupled to conduit 1213, and increase the air pressure in air compressor 1213 and conduit 1215. Compression device 1210 is configured so that it exerts a compressive force on a patient to reduce the likelihood that blood could pool or accumulate and result in DVT. For example, during operation, portable energy source 1230 can be used increase the temperature and pressure of compression device 1210 to increase blood flow to the area of the patient proximal to compression device 1210.

Coupling mechanism 1220 can be used to restrict the expansion of bladder 1214 in the outward direction (e.g., the direction away from the patient). In this manner, the expansion of bladder 1214 can exert a sufficient compressive force towards the patient to reduce blood pooling and accumulation. Energy source 1230 and air compressor 1213 can be configured to cyclically inflate and deflate bladder 1214, providing an alternating or cyclical compressive force to the patient.

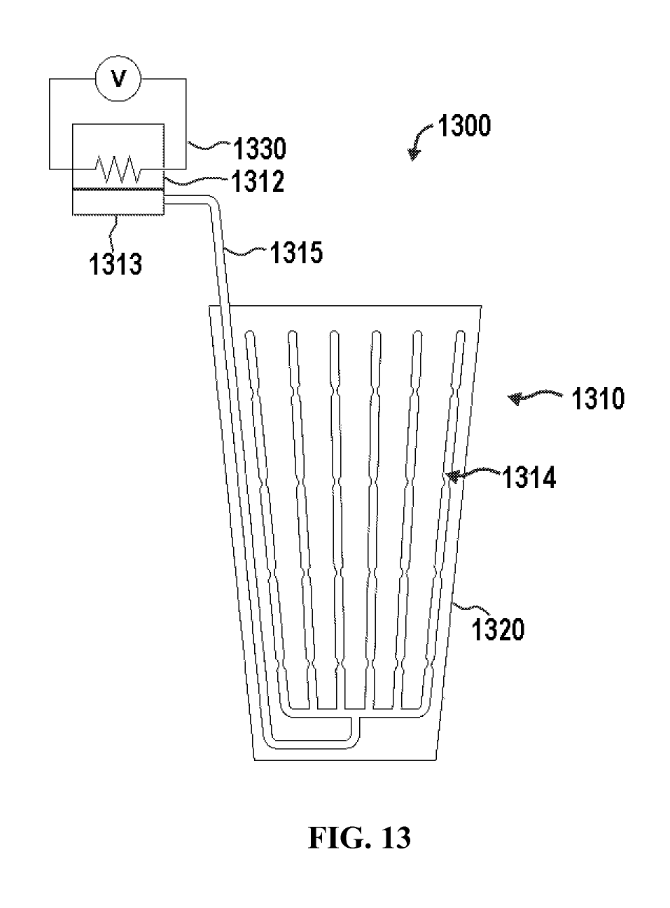

Referring now to FIG. 13, another exemplary embodiment of a DVT prophylaxis system 1300 is illustrated. The general configuration of this embodiment is similar to that described above in the embodiment of FIG. 9A. In this embodiment, however, a heater 1312 is incorporated in addition to an air compressor 1313. In this exemplary embodiment, a coupling mechanism 1320 may comprise an elastic sleeve or band that can be placed or wrapped around the patient's leg. In other embodiments, coupling mechanism 1320 may be configured to couple system 1300 to other portions of a patient.

In this embodiment, portable energy source 1330 may be energized to increase the temperature of heater 1312, which is coupled to conduit 1313, and increase the air pressure in air compressor 1313 and conduit 1315. Compression device 1310 is configured so that it exerts a compressive force on a patient to reduce the likelihood that blood could pool or accumulate and result in DVT. For example, during operation, portable energy source 1330 can be used increase the temperature and pressure of compression device 1310 to increase blood flow to the area of the patient proximal to compression device 1310.

Coupling mechanism 1320 can be used to restrict the expansion of bladder 1314 in the outward direction (e.g., the direction away from the patient). In this manner, the expansion of bladder 1314 can exert a sufficient compressive force towards the patient to reduce blood pooling and accumulation. Energy source 1330 and air compressor 1313 can be configured to cyclically inflate and deflate bladder 1314, providing an alternating or cyclical compressive force to the patient.

It should be understood that the present system, kits, apparatuses and methods are not intended to be limited to the particular forms disclosed. Rather, they are to cover all modifications, equivalents, and alternatives falling within the scope of the claims. By way of non-limiting example, the compression device may comprise mechanical pinchers or other mechanisms suitable for applying a compressive force to the patient.

The claims are not to be interpreted as including means-plus- or step-plus-function limitations, unless such a limitation is explicitly recited in a given claim using the phrase(s) “means for” or “step for,” respectively.

The term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

In the foregoing Detailed Description of Exemplary Embodiments, various features are grouped together in several embodiments for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description of Exemplary Embodiments, with each claim standing on its own as a separate embodiment.

1. A system for deep vein thrombosis prophylaxis, the system comprising:
a compression device configured to apply pressure to a skin surface of a patient;
a coupling mechanism configured to couple the compression device to a patient; and
a portable energy source coupled to the compression device, wherein the portable energy source is configured to supply energy to the compression device.

2. The system of claim 1 wherein the compression device is configured to exert a compressive force on the patient during use.

3. The system of claim 2 wherein the compression device is configured to exert a cyclic compressive force on the patient during use.

4. The system of claim 1 wherein the compression device comprises a pneumatic-actuated bladder.

5. The system of claim 4 wherein during use the pneumatic-actuated bladder is configured to expand and exert a compressive force on the patient.

6. The system of claim 1 wherein the compression device comprises a shape memory alloy.

7. The system of claim 6 wherein during use the shape memory alloy is configured to change shape when portable energy source is energized.

8. The system of claim 6 wherein the shape memory alloy is integrated in the coupling mechanism.

9. The system of claim 1 wherein the compression device comprises mechanical rollers.

10. The system of claim 9 wherein the mechanical rollers are eccentric mechanical rollers.

11. The system of claim 1 wherein the compression device comprises mechanical pinchers.

12. The system of claim 1 wherein the compression device comprises an ultrasonic emitter.

13. The system of claim 1 wherein the portable energy source comprises a rechargeable battery.

14. The system of claim 1 wherein the portable energy source comprises a rechargeable battery pack configured to be worn on a belt of a patient.

15. The system of claim 1 wherein the coupling mechanism comprises an elastic sleeve or band.

16. The system of claim 1 wherein the coupling mechanism comprises an elastic boot.

17. The system of claim 1 wherein the coupling mechanism is configured to couple the compression device to the leg of the patient.

18. The system of claim 1 wherein the coupling mechanism is configured to couple the compression device to the calf or thigh of the patient.

19. A method of preventing deep vein thrombosis in a patient, the method comprising:
providing a system according to any of the preceding claims;
coupling the compression device to the patient;
supplying energy to the compression device from the portable energy source; and
applying a compressive force to the patient from compression device.

20. The method of claim 19 wherein the compressive force is applied cyclically.
